(19) United States
(12) Patent Application Publication
(10) Pub. No.: US 2014/0053075 A1
(43) Pub. Date: Feb. 20, 2014

(54) CONTENT SUPPLYING APPARATUS, CONTENT SUPPLYING METHOD, PORTAL SYSTEM AND STORAGE MEDIUM STORING COMPUTER PROGRAM

(71) Applicant: NEC Corporation, Tokyo (JP)

(72) Inventor: KOUJI KATOU, Tokyo (JP)

(73) Assignee: NEC Corporation, Tokyo (JP)

(21) Appl. No.: 13/966,984

(22) Filed: Aug. 14, 2013

(30) Foreign Application Priority Data
Aug. 17, 2012 (JP) 2012-180955

(51) Int. Cl. G06F 3/0484

(52) U.S. Cl. CPC G06F 3/0484
USPC 715/738

(57) ABSTRACT

Disclosed is a content supplying apparatus or the like which can supply information, to be needed by a user quickly, even if a browsing environment of a portal site is different.

A content supplying apparatus 1 calculates a first priority P1 based on first terminal information 101, indicating information on a configuration of a terminal which accesses a portal site; by referring to priority information 4 obtained by associating a portlet included in the portal site, a priority range indicating a range to which the first priority P1 can be applied, and a display range in the portlet, based on any portlet and the calculated first priority P1, acquires information indicating the display range associated with the any portlet and the calculated first priority P1; and supplies the terminal with the any portlet and the acquired information indicating the display range.

This application is based upon and claims the benefit of priority from Japanese Patent Application No. 2012-180955, filed on Aug. 17, 2012, the disclosure of which is incorporated herein in its entirety by reference.

### TECHNICAL FIELD

The present invention relates to a technical field of supplying the most suitable contents, which should be displayed in a portal site, for example, based on an operational environment of a terminal.

### BACKGROUND ART

In recent years, a plurality of websites (hereinafter, referred to also as “Web site”) exist as a result of the prevailing Internet. As a system to manage a plurality of the Web sites efficiently, for example, a portal site (hereinafter, referred to also as “portal”) is generally known.

The portal site includes not only a portlet (hereinafter, referred to also as “portlet contents”) which has having various functions of a mail, schedule management, document management, directory and the like but also a function of consolidating accesses to various transaction processing systems.

As a result, for example, a company which introduces the portal site can execute transactions efficiently by sharing much information, which exists scatteringly in an inside of the company, through the portal site.

As a related art which has been proposed previously to the present application, for example, a Patent Literature 1 discloses an art that useless information, which is included in information composing a web page or the like, is removed and only information which each user needs is displayed.

More specifically, an information supplying server disclosed in the Patent Literature 1 accesses a web page which an user designates, and acquires information on composition (composition information) from the web page.

Next, the information supplying server divides the acquired composition in an unit of a line. The information supplying server generates a screen which is used for selecting the line on the basis of the composition information divided in an unit of the line.

According to the Patent Literature 1, the user selects required composition information on the screen which is used for selecting the line. Moreover, the information supplying server supplies the composition information which the user selects.

As a result, it is possible according to the Patent Literature 1 to use a screen area, which has a limited space, efficiently by removing the useless information which the user does not select, and displaying left information.

Furthermore, according to the Patent Literature 1, in the case of supplying a terminal, which has limitation in a browsing environment, such as a mobile information terminal or the like, with the composition information, the user selects composition information, which the user desires browsing, in advance.

As a result, in the case of browsing by using the mobile information terminal or the like, the information supplying server supplies the composition information which the user selects in advance.

A Patent Literature 2 discloses an art that a whole of a portal screen is displayed at a time with no necessity to scroll the portal screen.

More specifically, a computer disclosed in the Patent Literature 2 calculates a value of an area (henceforth, referred to as “portlet display area value”), which can be used for displaying a portlet included in a window, based on information on a display area of the window. The computer makes the calculated portlet display area value store in a storage device.

Next, when displaying the portlet on the window, the computer refers to the portlet display area value which is stored in the storage device.

The computer adjusts contents of the portlet, which should be displayed, based on the referred portlet display area value, and displays the adjusted portlet.

A Patent Literature 3 discloses an art that, in the case that a plurality of kinds of dedicated terminals are connected with one server and are used in a state of the connection, the terminal is set automatically without being set by an user so as to be matched with an execution environment which is different per the terminal.

More specifically, the terminal disclosed in the Patent Literature 3 sends identification information which can identify the terminal, identification information which can identify an input device such as a keyboard or the like, and a size of a display screen to a server as composition information.

The server determines an application program, which is suitable to the terminal, based on a table and the composition information which is received from the terminal. The server activates the determined application program.

Here, the table indicates that the composition information of the terminal which the server stores in advance, and the application program which is suitable to the terminal are associated each other.

The server generates image data, which is matched with the display screen size included in the composition information, based on the activated application program. The server sends the generated image data to the terminal.

The terminal displays the image data, which is received from the server, by using a display means.

According to an art disclosed in a Patent Literature 4, an order of displaying display elements is determined dynamically according to a change in a display condition.

As a result, according to the art disclosed in the Patent Literature 4, it is possible to display important information preferentially, and it is also possible to prevent deformation of a graphic shape, and distortion of a displayed character or the like which are caused when scaling up or scaling down a whole area or any area on a screen.

More specifically, according to the art disclosed in the Patent Literature 4, when scaling up or scaling down a display element such as the character, the figure or the like which is displayed on a display device of an equipment or the like, a preferential order of displaying the display elements (preferential display order) on the screen is determined based on a scale-up/scale-down rate. According to the art, the display element is displayed on the screen based on the determined preferential display order.

A Patent Literature 5 discloses an art that a portlet which is used frequently is displayed at the most suitable position for an user.

More specifically, in the case that a terminal accesses a portlet which is displayed on a portal site, a portal server disclosed in the Patent Literature 5 stores access information which is obtained by associating date/time information which indicates a date and time when the access is activated, and specific information which specifies the accessed portlet.

When the terminal requests that the portal site should be displayed again, the portal server calculates utilization frequency of the portlet per a time zone based on the stored access information.

The portal server changes a layout of the portlet, which is displayed in the portal site, based on the calculated utilization frequency.

### PRECEDING TECHNICAL LITERATURE

### Patent Literature

[Patent Literature 1] Japanese Patent Application Laid-Open No. 2002-312391
[Patent Literature 2] Japanese Patent Application Laid-Open No. 2004-252688
[Patent Literature 3] Japanese Patent Application Laid-Open No. 2007-179108
[Patent Literature 4] Japanese Patent Application Laid-Open No. 1999(H11)-007316
[Patent Literature 5] Japanese Patent Application Laid-Open No. 2012-033013

### BRIEF SUMMARY OF THE INVENTION

### Problem to be Solved by the Invention

By the way, the portal site mentioned above is accessed by many users according to characteristics of the portal site. Moreover, when accessing the portal site, an user accesses the portal site by using various terminals such as a personal computer (hereinafter, abbreviated as “PC”), a cellular phone, a tablet PC or the like.

For example, in the case that the user accesses the portal site by using the cellular phone, a screen size of the cellular phone is small. As a result, there is a problem that some of all contents which are included in the portal site are not displayed or the contents are displayed with a screen layout being distorted.

Furthermore, there is also a problem that, in the case of the cellular phone, a part of an image can not be displayed since a capacity of a page capable of displaying is limited.

On the other hand, in the case that the user accesses the portal site by using PC, a screen size of PC is large. As a result, all contents which are included in the portal site are displayed.

Therefore, to cope with the problem mentioned above, a portal server which is generally known judges a classification of a web browser, which is used in the terminal, in response to an access request (hereinafter, denoted also as “request”) issued by the terminal. Then, the portal server responds the access request by converting contents so as to be matched with the classification of the judged browser.

Or a portal site manager prepares two portal sites, which are used for the PC and for the mobile terminal respectively.

As a result, in the case that an access request is issued by the terminal, the portal server processes the access request by judging the classification of the terminal and sending the portal site, which is prepared so as to be matched with the judged classification of the terminal, to the terminal.

However, according to the above-mentioned method of converting the contents, converting the contents is carried out to all information which is included in the portal site.

Therefore, according to the method, in the case that, for example, the cellular phone displays the portal site, useless information for the user is displayed and furthermore it takes much time to display the portal site.

Furthermore, a layout to which converting the contents has been carried out is different from a layout based on intention of a content-provider.

For this reason, there is a problem that the portal site which the cellular phone displays is inconvenient and inefficient for the user.

Moreover, according to the above-mentioned method of preparing the portal site per the terminal, it is necessary to generate a plurality of the portal sites, and furthermore it takes much time and effort to manage the generated portal site.

More specifically, the portal site includes a large amount of portlet content information. Therefore, the portal site manager desires not to manage the portal site per the terminal but to manage one portal site.

Furthermore, according to the Patent Literature 1, in the case of browsing from a specific terminal, the user needs time and effort of selecting contents, which the user desires to browse, in advance.

Furthermore, the Patent Literature 1 describes merely that, in the case of browsing by using the mobile information terminal or the like, the selected contents are displayed, and the Patent Literature 1 does not refer to a case of browsing from an unspecified number of the terminals.

Moreover, according to the Patent Literature 2, the portal site is adjusted so as to be matched with an area (display area) capable of displaying in the web browser, and the adjusted portal site is displayed on one screen.

According to the Patent Literature 2, for example, the portal site is adjusted so as to be matched with the display area of the web browser which the mobile terminal such as the cellular phone or the like has, and the adjusted portal site is displayed on one screen.

That is, the portal site is displayed in a scaled-down state so as to be matched with the screen size of the cellular phone. Therefore, the user cannot read contents of the portal site which is displayed in the scaled-down state.

The Patent Literature 3 describes merely that the image data is generated based on the table prepared in advance and the generated image data is displayed, and the Patent Literature 3 does not refer to a method for displaying the portlet which is included in the portal site.

The Patent Literature 4 describes merely that the display element such as the character, the figure or the like is scaled up or scaled down based on the designated scaling-up/scaling-down rate, and the Patent Literature 4 does not refer to a size of a display monitor, and displaying in an unspecified number of the terminals.

The Patent Literature 5 describes merely that the layout of the portlet, which the portal site displays, is changed based on the utilization frequency of the portlet, and the Patent Literature 5 does not refer to the size of the display monitor, and displaying in an unspecified number of the terminals.

A main object of the present invention is to provide a content supplying apparatus and the like which can supply an user quickly with information needed by the user even in the case that an environment for browsing a portal site is different.

### SUMMARY

In order to achieve the above-mentioned problem, a content supplying apparatus according to the present invention is characterized by including the following configuration.

That is, the content supplying apparatus according to the present invention is characterized in that:

calculating a first priority based on first terminal information indicating information on a configuration of a terminal which accesses a portal site;

by referring to priority information obtained by associating a portlet included in the portal site, a priority range indicating a range to which the first priority can be applied, and a display range in the portlet, based on any portlet and the calculated first priority, acquiring information indicating the display range which is associated with the any portlet and the calculated first priority, and

supplying the any portlet, and the acquired information indicating the display range to the terminal.

The aforementioned object is also achieved by a portal system which includes the content supplying apparatus mentioned above.

In order to achieve the object, a content supplying method according to the present invention is characterized by having the following composition.

That is, the content supplying method according to the present invention is characterized by comprising:

calculating a first priority based on first terminal information, indicating information on a configuration of a terminal which accesses a portal site;

by referring to priority information, which is obtained by associating a portlet which is included in the portal site, a priority range indicating a range to which the first priority can be applied and a display range in the portlet, based on any portlet and the calculated first priority, acquiring information indicating the display range associated with the any portlet and the calculated first priority; and

supplying the terminal with the any portlet, and the acquired information indicating the display range.

The aforementioned object is also achieved by a computer program which realizes the content supplying apparatus and the contents supplying method having above-mentioned composition by using a computer, or the same object is achieved by a non-transitory computer readable storage medium which stores the computer program.

### BRIEF DESCRIPTION OF THE DRAWINGS

Exemplary features and advantages of the present invention will become apparent from the following detailed description when taken with the accompanying drawings in which:

FIG. 1 is a block diagram showing a configuration of a content supplying apparatus according to a first exemplary embodiment of the present invention.

FIG. 2 exemplifies priority information according to the first exemplary embodiment of the present invention.

FIG. 3 is a block diagram showing a configuration of a content supplying apparatus according to a second exemplary embodiment of the present invention.

FIG. 4 exemplifies portlet information conceptually according to the second exemplary embodiment of the present invention.

FIG. 5 is a block diagram showing a configuration of a portal system according to a third exemplary embodiment of the present invention.

FIG. 6 is a flowchart showing an operation which is carried out by a content supplying apparatus according to the third exemplary embodiment of the present invention.

FIG. 7 is a block diagram which describes exemplarily a hardware configuration of an information processing apparatus which can realize each exemplary embodiment according to the present invention.

### EXEMPLARY EMBODIMENT

Hereinafter, an exemplary embodiment according to the present invention will be described in detail with reference to a drawing.

### First Exemplary Embodiment

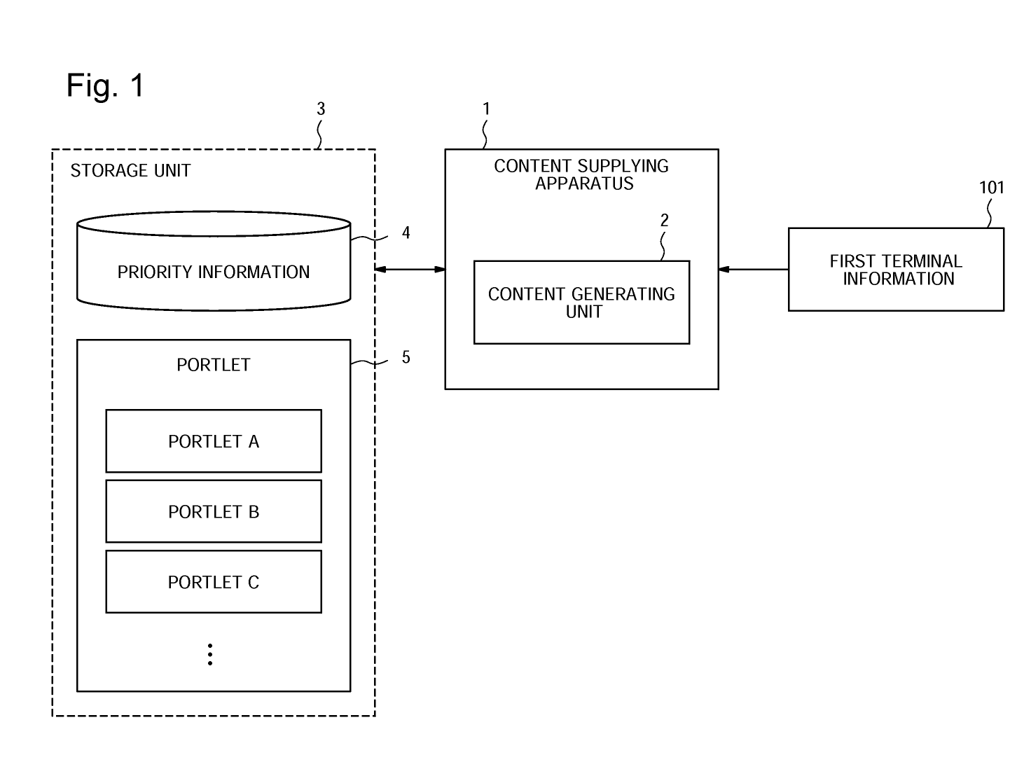

FIG. 1 is a block diagram showing a configuration of a content supplying apparatus 1 according to a first exemplary embodiment of the present invention.

As shown in FIG. 1, the content supplying apparatus 1 includes a content generating unit 2.

The content generating unit 2 calculates a first priority P1 based on a first terminal information 101. Furthermore, the content generating unit 2 refers to priority information 4, which a storage unit 3 holds, based on the calculated first priority P1.

Next, as a result of referring to the priority information 4 based on the calculated first priority P1, the content generating unit 2 acquires information which indicates a display range in a portlet. The content generating unit 2 supplies any portlet and information which indicates the display range in the portlet. In this exemplary embodiment, “portlet” means a component, which is included in a portal site, such as schedule control, mailing, or the like (above mention is similar in the following exemplary embodiment).

Next, a more specific operation of the content supplying apparatus 1 according to the first exemplary embodiment of the present invention will be explained.

The storage unit 3 holds the priority information 4 and a portlet 5.

The storage unit 3 is a non-volatile storage device from and in which a computer reads and writes data respectively. As a more specific example, a non-volatile storage device, which is installed in an electronic apparatus such as a server or the like, such as a hard disk drive (hereinafter, referred to as “HDD”) can be used as the storage unit 3.

Moreover, as an example, a storage device (not shown in the figure), which is connected with a communication network. (not shown in the figure), may be used as the storage unit 3. However, the present invention, which is exemplified by using the exemplary embodiment, is not limited to the configuration mentioned above (this can be applied to the following exemplary embodiment, also).

The portlet 5 means a plurality of portlet (portlet A, portlet B and portlet C) groups which are included in the portal site.

To make the description easy, the example that the portlet 5 includes the portlet A, the portlet B and the portlet C has been described according to the exemplary embodiment mentioned above. However, the present invention is not limited to the configuration. The portlet 5 may include one portlet or a plurality of portlets (a portlet 5 according to the following exemplary embodiment is similar).

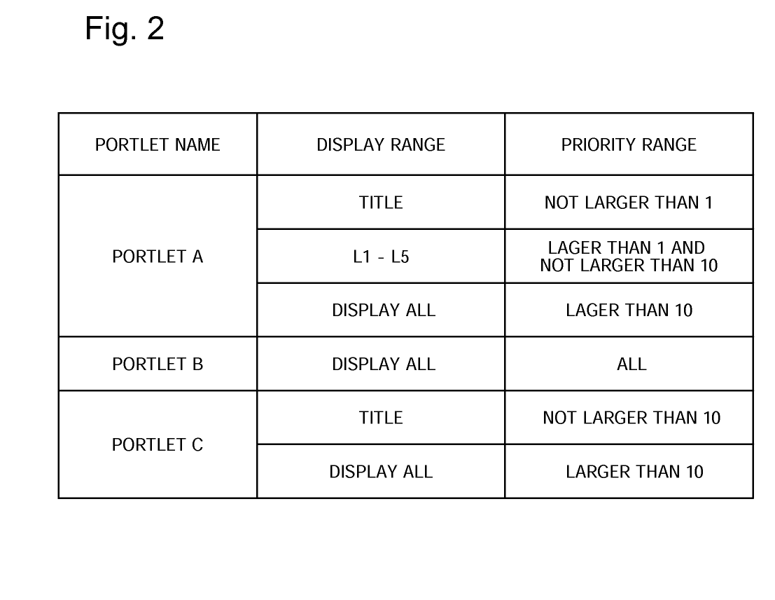

FIG. 2 exemplifies the priority information 4 conceptually according to the first exemplary embodiment of the present invention.

In FIG. 2, the priority information 4 is a record which is obtained by associating a portlet name, the display range and the priority range.

As a more specific example, the priority information 4 includes the portlet name in a first column of a table shown in FIG. 2. Furthermore, the priority information 4 includes information, which indicates the display range, in a second column. The priority information 4 includes information, which indicates the priority range, in a third column.

Here, the portlet name means a name of a portlet included in the portlet 5 (that is, portlet group) which the storage unit 3 holds and which is included in the portal site. Moreover, the priority range means information indicating a range to which the first priority P1, which the content generating unit 2 calculates based on the first terminal information 101, can be applied. Furthermore, the display range means information indicating a display range of a portlet which is associated with the portlet name and the priority range (first priority P1 will be described later in the exemplary embodiment).

Moreover, the priority range is set per the portlet. Furthermore, the priority range is divided according to the range to which the first priority P1 is applied.

As a more specific example, in the case that an amount of information displayed in the portlet is large, the priority range may be divided according to a page capacity of the cellular phone in which contents can be displayed, or may be divided with considering a bandwidth of a network circuit. However, the present invention, which is exemplified by using the exemplary embodiment, is not limited to the configuration mentioned above (this can be applied to the following exemplary embodiment, also).

The display range is set so as to be matched with the priority range which is set.

As a more specific example, in the case that the first priority P1 is low, the display range may be set so that an amount of information displayed in the portlet may be small. On the other hand, in the case that the first priority P1 is high, the display range may be set so that a whole of the portlet may be displayed.

Moreover, the display range may be set, for example, so that a portal site manager may select contents, which should be displayed, optionally and set the selected contents optionally.

As a result, the portal site manager can display the contents, which the portal site manager intends to display, to an user.

That is, the portal site manager can assign a preferential order to the contents which should be displayed. However, the present invention, which is exemplified by using the exemplary embodiment, is not limited to the configuration mentioned above (this can be applied to the following exemplary embodiment, also).

The priority information 4 is held by the storage unit 3 in advance.

The priority information 4, for example, may be registered with the storage unit 3 in advance by the portal site manager. However, the present invention, which is exemplified by using the exemplary embodiment, is not limited to the configuration mentioned above (this can be applied to the following exemplary embodiment, also).

As a more specific example, the portal site manager divides a priority range of the portlet-A, which is exemplified in FIG. 2, into the following three categories.
Information indicating “not larger than 1”,
Information indicating “larger than 1 and not larger than 10”, and
Information indicating “larger than 10”.

Next, the portal site manager sets a range (display range), which displays the portlet A, so as to be matched with the priority range which is set.

As a more specific example, in the case that the priority range indicates “not larger than 1”, the display range is set as a range indicating “title” which is included in the portlet A.

In the case that the priority range indicates “larger than 1 and not larger than 10”, the display range is set as a range indicating “L1-L5” which is included in the portlet A. That is, according to the priority range, a first line to a fifth line, which are included in the portlet A, are set as the display range.

In the case that the priority range indicates “larger than 10”, the display range is set as a range indicating “display all” which is included in the portlet A.

It is noted that, the present invention is not limited to the exemplary embodiment mentioned above. For example, the priority range may be set as one category or a plurality of categories in the present invention. According to the above-mentioned setting, the display range may be set so as to be matched with the priority range.

Next, the first terminal information 101 is corresponding to information on a configuration of a terminal (not shown in the figure) which browses the portal site. More specifically, the first terminal information 101 is corresponding to information (screen size) which indicates a size of a screen of a display device or the like included in the terminal, and indicates information (memory size) on a main memory device (hereinafter, denoted merely as “memory”) which is included in the terminal and which is available when browsing the portal site.

According to receiving the first terminal information 101, the content generating unit 2 calculates the first priority P1 based on the screen size and the memory size which are included in the received first terminal information 101.

Here, a method for calculating the first priority P1 will be described. In the exemplary embodiment, the content generating unit 2 calculates the first priority P1 based on the following formula (1).

The first priority P1=α×(screen size)×β×(memory size) (1)

In the above-mentioned formula (1), it is possible to find the first priority P1 by multiplying the screen size and the memory size by a predetermined multiplier (α, β). Here, the portal site manager may determine the multiplier optionally (this can be applied to the following exemplary embodiment, also).

Next, the content generating unit 2 refers to the priority information 4, which is held by the storage unit 3, based on the portlet which is included in the portal site, and the calculated first priority P1.

As a result of referring to the priority information 4 based on the any portlet which is included in the portal site, and the calculated first priority P1, the content generating unit 2 acquires information indicating a display range which is associated, as shown in FIG. 2, with the portlet name (that is, any portlet) and the priority range which includes a value of the first priority P1.

The content generating unit 2 supplies the portlet name and the acquired information which indicates the display range. That is, for example, the content generating unit 2 supplies the terminal with the portlet content information which is included in the portal site.

In this embodiment, as the portlet content information, the portlet name and the acquired information indicating the display range are exemplified.

As a more specific example, the value of the first priority P1 which the content generating unit 2 calculates is assumed to be “1”. Moreover, it is assume that the portal site includes the portlet A, the portlet B and the portlet C.

The content generating unit 2 refers to the priority information 4 based on the portlet which is included in the portal site, and the calculated first priority P1 “1”. As a result of referring to the priority information 4, the content generating unit 2 acquires information indicating a display range which is associated with the portlet name, and the priority range which includes the value of the first priority P1.

That is, in the case that the first priority P1 indicates “1”, the content generating unit 2 acquires information indicating “title” as the information indicating a display range which is associated with the portlet A shown in FIG. 2. Furthermore, the content generating unit 2 acquires information indicating “display all” as information indicating a display range which is associated with the portlet B shown in FIG. 2. The content generating unit 2 acquires information indicating “title” as information indicating a display range which is associated with the portlet C shown in FIG. 2.

The content generating unit 2 supplies the portlet name and the acquired information indicating the display range which is associated with the portlet.

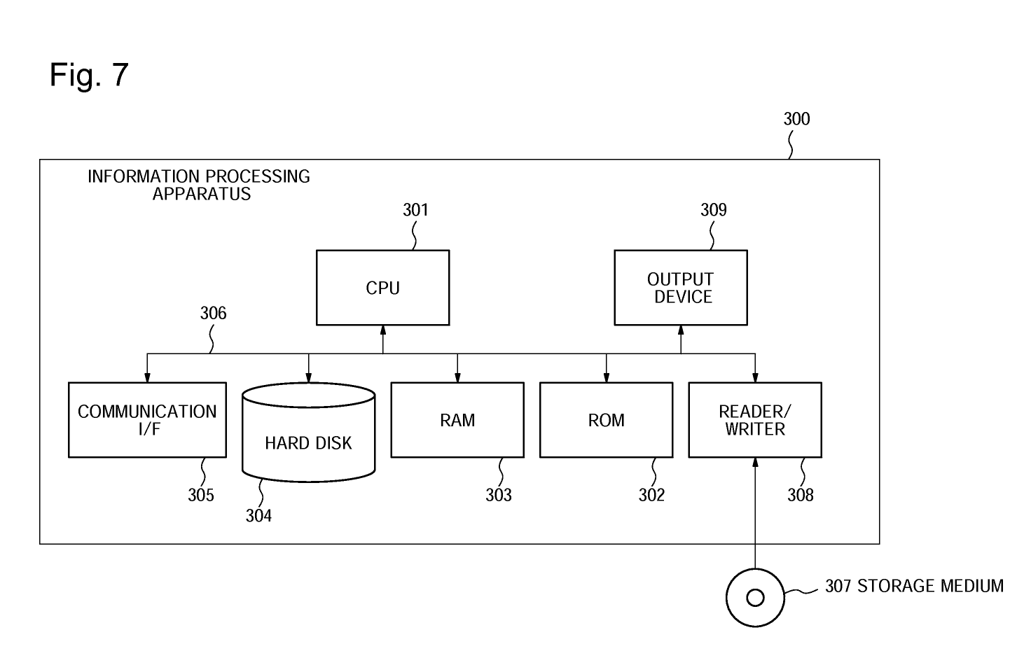

For example, a web browser of the terminal (not shown in the figure) displays the portal site to the user via an user interface such as a display device or the like (for example, an output unit 309 shown in FIG. 7 which will be described later), which is included in the terminal, based on the received portlet name and the acquired information indicating the display range which is associated with the portlet.

It is noted that, to make the description easy, the example that the portal site includes the portlet A, the portlet B and the portlet C has been described in the exemplary embodiment mentioned above. However, the present invention is not limited to the configuration. For example, the portal site may include the portlet A and the portlet C, or the portal site may include one or plural portlets (this can be applied to the following exemplary embodiment, also).

According to the content supplying apparatus 1 of the exemplary embodiment, it is possible to supply information, which an user needs, quickly even in the case that an environment for browsing the portal site is different. The reason is that the content supplying apparatus 1 can select the range of the portlet, which should be displayed, so as to be matched with the composition (screen size and memory size) of the terminal which browses the portal site, and can display the selected portlet content information which is included in the portal site.

That is, in the case of displaying the portal site to the mobile terminal or the like whose sizes of the screen and the memory used for displaying the portal site are small, the content supplying apparatus 1 can decrease an amount of the information to be displayed. On the other hand, in the case of displaying the portal site to PC whose sizes of the screen and the memory used for displaying the portal site are large, the content supplying apparatus 1 can increase an amount of the information to be displayed.

As a result, it is possible to decrease an amount of communication data since an amount of the portlet content information is small in the case of the mobile terminal. That is, the mobile terminal can display the portal site quickly. PC can display much information.

Moreover, the portal site manager can save a time and effort for generating and managing the portal site per the terminal. The reason is that the portal site manager can adjust the display range of the portal site per the terminal.

### Second Exemplary Embodiment

Next, a second exemplary embodiment, which is based on the content supplying apparatus 1 according to the first exemplary embodiment of the present invention mentioned above, will be described. The following description will focused on a characteristic point of the exemplary embodiment. In this case, the same component as one according to the first exemplary embodiment mentioned above is assigned the same reference number as one according to the first exemplary embodiment, and description on the component is omitted.

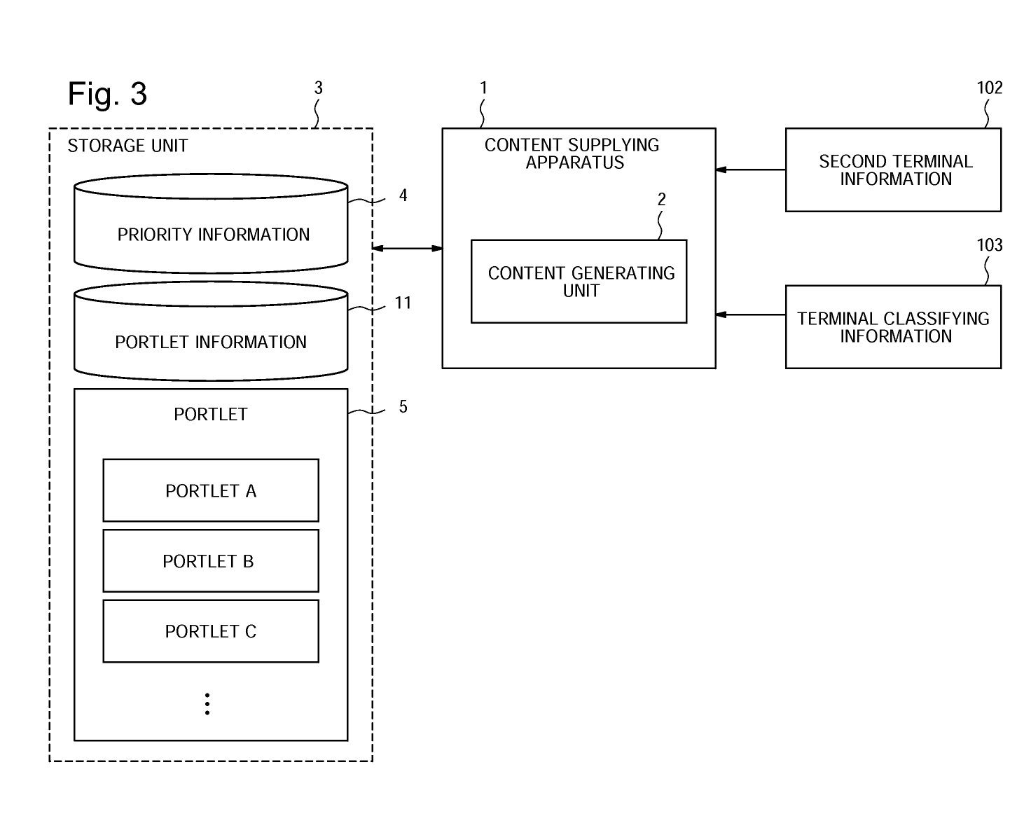

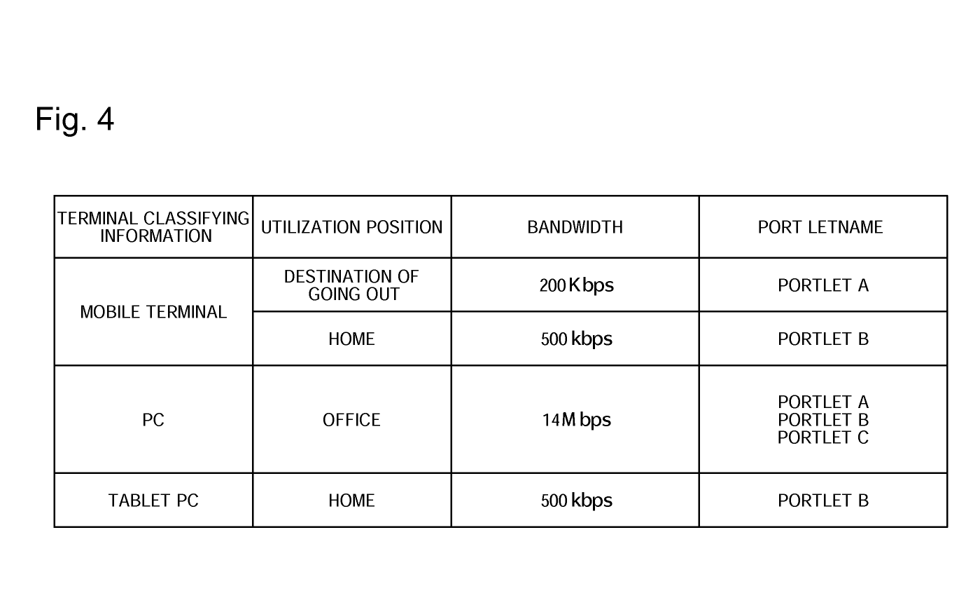

The content supplying apparatus 1 according to the second exemplary embodiment of the present invention will be described with reference to FIG. 3 and FIG. 4.

FIG. 3 is a block diagram showing a configuration of the content supplying apparatus 1 according to the second exemplary embodiment of the present invention.

In FIG. 3, the storage unit 3 has portlet information 11 furthermore.

FIG. 4 exemplifies the portlet information 11 conceptually according to the second exemplary embodiment of the present invention.

The portlet information 11 shown in FIG. 4 is corresponding to a record which is obtained by associating information indicating a classification of a terminal, for example, information indicating a position where an user uses the terminal (hereinafter, denoted also as “utilization position information” or “utilization location information”), and a bandwidth of a network circuit.

More specifically, the portlet information 11 includes information (terminal classification) on the classification of the terminal in a first column of a table shown in FIG. 4. Furthermore, the portlet information 11 includes the utilization position information (utilization position) of the terminal in a second column. The portlet information 11 includes the bandwidth per the terminal in a third column. Furthermore, the portlet information 11 includes a portlet name in a fourth column.

The classification information of the terminal means information indicating a classification of a terminal which sends an access request (hereinafter, also referred to as “request”) to the portal server. That is, the classification information of the terminal means information indicating a classification of a terminal which browses the portal site.

Moreover, the utilization position means information which indicates a position where an user uses the terminal when browsing the portal site.

To make the description easy in the exemplary embodiment mentioned above, the example that the utilization position information shown in FIG. 4 indicates “destination of going out”, “home” and “office” has been explained. However, the utilization position information indicates an IP (Internet Protocol: hereinafter, referred to as “IP”) address and a range of the IP addresses which are assigned to various terminals per the classification of the terminal and per the utilization position.

The present invention is not limited to the exemplary embodiment mentioned above. For example, the present invention may adopt information on an access point as the utilization position information or may adopt the latitude/longitude which can be acquired by using GPS (Global_Positioning_System: hereinafter, referred to as “GPS”). Moreover, the present invention may adopt a MAC (Media_Access_Control: hereinafter, referred to as “MAC”) address as the utilization position information. However, the present invention, which is exemplified by the exemplary embodiment, is not limited to the configuration mentioned above (above mention is similar in the following exemplary embodiment).

The bandwidth means information indicating a bandwidth of a network circuit which is specified by the classification of the terminal and the utilization position.

For example, the bandwidth may be registered by the portal site manager with the portlet information 11, or the bandwidth may be registered with the portlet information 11 by an user's operating a registration screen which the portal site manager provides as an user interface. However, the present invention, which is exemplified by the exemplary embodiment, is not limited to the configuration mentioned above (above mention is similar in the following exemplary embodiment).

It is noted that, the art of registering the bandwidth with the portlet information 11 by the user's operating the registration screen is realized by adopting an art which is general at this point of time. Therefore, detailed description on the art is omitted in the exemplary embodiment (above mention is similar also in the following embodiment).

The portlet name means information indicating a name of a portlet which is associated with the classification information and the utilization position information of the terminal shown in FIG. 4.

As a more specific example, in the case that an user accesses a portal site by using a mobile terminal at a destination of going out, the portal site includes the portlet A which is associated with “mobile terminal” and “destination of going out” shown in FIG. 4.

Next, a second terminal information 102 includes information, which indicates a position where the terminal is utilized, in addition to the first terminal information 101 which is described in the first exemplary embodiment.

That is, the second terminal information 102 means information which indicates a size of a screen (screen size), memory information (memory size) and the utilization position information.

The IP address assigned to the terminal is exemplified as the utilization position information.

The present invention is not limited to the exemplary embodiment mentioned above. For example, the present invention may adopt the information on the access point which the terminal accesses or may adopt information on the latitude/longitude which can be acquired by using GPS. Moreover, the present invention may adopt the MAC address which can specify the terminal or the like uniquely. However, the present invention, which is exemplified by the exemplary embodiment, is not limited to the configuration mentioned above (above mention is similar in the following exemplary embodiment).

Next, a terminal classifying information 103 means information which indicates a classification of a terminal (not shown in the figure) which browses the portal site. More specifically, the terminal classifying information 103 means information indicating a classification of a terminal such as “mobile terminal”, “PC”, “tablet PC” or the like in the exemplary embodiment.

To make the description easy in the present invention which is exemplified by the exemplary embodiment, the case that the information, which indicates the classification of the terminal such as “mobile terminal”, “PC”, “tablet PC” or the like, is used as the terminal classifying information 103 has been described. However, the present invention is not limited to the case. Information indicating a classification of a web browser at the terminal, which browses the portal site, may be used as the terminal classifying information 103. However, the present invention, which is exemplified by the exemplary embodiment, is not limited to the configuration mentioned above (above mention is similar in the following exemplary embodiment).

According to receiving the second terminal information 102 and the terminal classifying information 103, the content generating unit 2 refers to the portlet information 11, which the storage unit 3 holds, based on the received second terminal information 102 and the received terminal classifying information 103.

More specifically, the content generating unit 2 refers to the portlet information 11, which the storage unit 3 holds, based on the utilization position information which is included in the second terminal information 102, and the classification information of the terminal which is included in the terminal classifying information 103.

Next, as a result of referring to the portlet information 11 based on the second terminal information 102 and the terminal classifying information 103, the content generating unit 2 acquires a bandwidth and a portlet name which are associated with the utilization position information and the classification information of the terminal.

That is, as a result of referring to the portlet information 11 based on the second terminal information 102 and specific terminal classifying information out of the terminal classifying information 103, the content generating unit 2 acquires a specific portlet and a specific bandwidth which are associated with the utilization position information and the specific terminal classifying information

As a more specific example, according to receiving the second terminal information 102 and the terminal classifying information 103, the content generating unit 2 refers to the portlet information 11, which the storage unit 3 holds, based on information indicating “destination of going out” which is corresponding to the utilization position information and which is included in the received second terminal information 102, and information indicating “mobile terminal” which is corresponding to the classification of the terminal and which is included in the terminal classifying information 103.

As a result, the content generating unit 2 acquires “200 kbps (kilobit/Second: hereinafter, referred to as “kbps”)” which is corresponding to the bandwidth, and “portlet A” which is corresponding to the portlet name which are associated with “destination of going out” corresponding to the utilization position information, and “terminal” corresponding the classification of the terminal.

The content generating unit 2 calculates a second priority P2 based on the screen size and the memory size which are included in the received second terminal information 102, and the acquired bandwidth (that is, specific bandwidth).

Here, a method for calculating the second priority P2 will be described. In the exemplary embodiment, the content generating unit 2 finds the second priority P2 by using the following formula (2).

The second priority P2=α×(screen size)×β×(memory size)×γ×(bandwidth) (2)

According to the above-mentioned formula (2), it is possible to find the second priority P2 by multiplying the screen size, the memory size and the bandwidth by a predetermined multiplier (α, β, γ). Here, the multiplier may be determined optionally by the portal site manager (this can be applied to the following exemplary embodiment, also).

Next, the content generating unit 2 refers to the priority information 4, which the storage unit 3 holds, based on the calculated second priority P2 and the acquired portlet name.

As a result of referring to the priority information 4 based on the second priority P2 and the portlet name, the content generating unit 2 acquires information indicating the display range which is associated with the portlet name (that is, specific portlet) and the priority range including a value of the second priority P2.

The content generating unit 2 supplies the portlet name and the acquired information indicating the display range which is associated with the portlet.

That is, for example, the content generating unit 2 supplies the terminal with portlet content information (specific portlet and information which indicates the display range) which is included in the portal site.

As mentioned above, the content supplying apparatus 1 according to the exemplary embodiment can obtain the same effect as one which is explained in the first exemplary embodiment mentioned above. Furthermore, the content supplying apparatus 1 can supply quickly information which an user needs. The reason will be described in the following. That is, the content supplying apparatus 1 has the portlet information 11 furthermore. Therefore, for example, the content supplying apparatus 1 can select the range of the portlet, which should be displayed, so as to be matched with the classification of the terminal which browses the portal site, the utilization position at which the terminal browses the portal site, and the transmission rate of the network circuit, and can supply the selected portlet content information which is included in the portal site.

Therefore, for example, in the case that an user accesses the portal site by using an mobile terminal whose transmission rate is low, the user who uses the mobile terminal can display the contents quickly since an amount of contents to be displayed is small.

Moreover, according to the exemplary embodiment, for example, in the case that the user accesses the portal site by using PC which is connected with the network whose transmission rate is low, the user who uses PC can display the contents quickly. The reason is that the calculated value of the second priority P2 is small since the transmission rate is low. Therefore, the content supplying apparatus 1 selects the display range of the portlet in accordance with the value of the second priority P2, and supplies the selected portlet content information which is included in the portal site. That is, the content supplying apparatus 1 can supply the portal site with using a small amount of information which is accorded with the transmission rate of the network circuit.

### Third Exemplary Embodiment

Next, a third exemplary embodiment, which is based on the content supplying apparatus 1 according to the second exemplary embodiment of the present invention mentioned above, will be described. The following description will focused on a characteristic point of the exemplary embodiment. In this case, the same component as one according to the exemplary embodiment mentioned above is assigned the same reference number as one according to the exemplary embodiment mentioned above, and description on the same component is omitted.

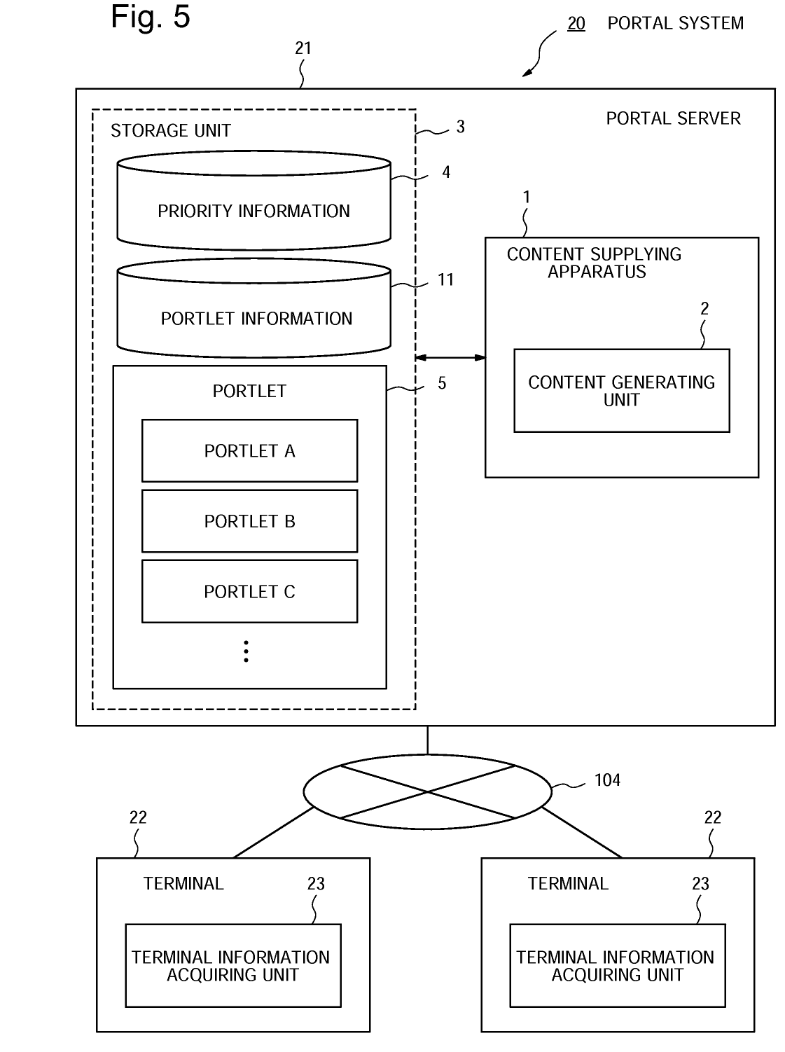

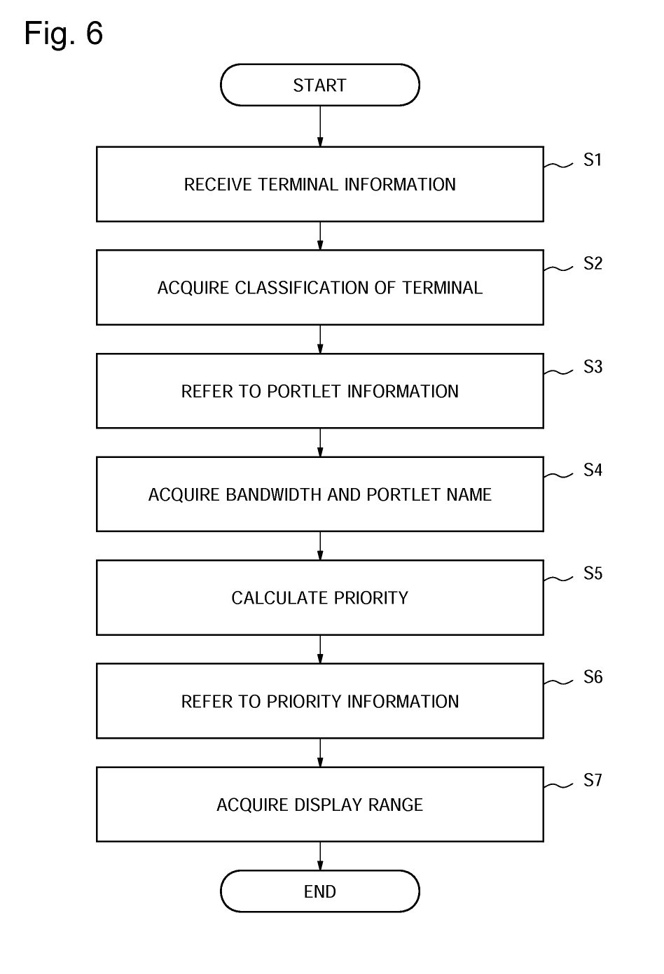

The content supplying apparatus 1 according to the third exemplary embodiment of the present invention will be described with reference to FIG. 5 and FIG. 6.

FIG. 5 is a block diagram showing a configuration of a portal system 20 according to the third exemplary embodiment of the present invention.

In FIG. 5, the portal system 20 includes a portal server 21 which is corresponding to the content supplying apparatus 1, and a terminal 22 mainly.

More specifically, according to the exemplary embodiment, the portal server 21 is corresponding to the generally known portal server including the content supplying apparatus 1 which is described in the second exemplary embodiment.

The terminal 22 is the generally known terminal such as PC, a cellular phone or a tablet PC. Since the terminal according to the exemplary embodiment is not a feature of the exemplary embodiment, a specific operation and a detailed configuration of the terminal 22 are omitted (this can be applied to the following exemplary embodiment, also).

More specifically, the terminal 22 includes a terminal information acquiring unit 23.

According to receiving portlet content information from the portal server 21, the terminal 22 displays the received portlet content information to the user via an user interface such as a display device or the like (not shown in the figure) of the terminal 22.

The terminal information acquiring unit 23 acquires configuration information of the terminal 22 (own apparatus) and sends the acquired configuration information to the portal server 21 via a network (communication network) 104 as the second terminal information 102.

Since an art that the terminal information acquiring unit 23 according to the exemplary embodiment acquires the configuration information on the terminal 22 is realized by adopting the art which is general at this point of time, detailed description on the art is omitted in the exemplary embodiment (this can be applied to the following exemplary embodiment, also).

Each of the portal server 21 and the terminal 22 includes a general communication interface which is not shown in FIG. 5. Moreover, the terminal 22 can access the portal server 21 via the network 104.

The network 104 is corresponding to various communication circuits which a cellular phone operator possesses, or a general communication circuit such as the Internet or the like which the internet service provider or the like provides.

Next, a more specific operation of the content supplying apparatus 1 according to the third exemplary embodiment of the present invention will be described.

In the following description, an operation which the content supplying apparatus 1 carries out when inputting the second terminal information 102 from the terminal information acquiring unit 23 of the terminal 22, will be described in detail as an example.

It is assumed that an user accesses the portal site, for example, by operating the terminal 22. That is, by the user's operating the web browser, the terminal 22 sends a request to the portal server 21.

Furthermore, it is assumed that the terminal 22 sends the second terminal information 102, for example, when logging in to the portal site.

It is noted that, as the above-mentioned configuration has been described as the example in order to make the description easy, the present invention is not limited to the configuration (above mention is similar in the following exemplary embodiment).

FIG. 6 is a flowchart showing the operation which the content supplying apparatus 1 according to the third exemplary embodiment of the present invention carries out. A procedure of the operation carried out by the content supplying apparatus 1 will be described based on the flowchart.

Step S1:

According to receiving the second terminal information 102 from the terminal 22, the content supplying apparatus 1 in the portal server 21 makes the content generating unit 2 carry out the process.

Step S2:

The content generating unit 2 acquires classification information of the terminal 22 based on information which is embedded in a header of the request sent by the terminal 22.

As a more specific example, the content generating unit 2 judges classification of the web browser based on the information which is embedded in the header of the request sent by the terminal 22. Next, the content generating unit 2 judges the classification of the terminal 22 based on the classification of the web browser. The content generating unit 2 acquires the judged classification as the classification information of the terminal 22. However, the present invention, which is exemplified by the exemplary embodiment, is not limited to the configuration mentioned above (above mention is similar in the following exemplary embodiment).

Since an art for acquiring the classification of the terminal based on the header of the request, which is sent by the terminal 22, is realized by adopting the art which is general at this point of time, detailed description on the art is omitted in the exemplary embodiment (above mention is similar also in the following embodiment).

The acquired classification information of the terminal 22 is corresponding to the terminal classifying information 103 described in the second exemplary embodiment. In this case, the classification information on the terminal 22 is corresponding to information indicating “mobile terminal”.

Step S3:

The content generating unit 2 refers to the portlet information 11, which the storage unit 3 holds, based on utilization position information which is included in the received second terminal information 102, and the acquired classification information of the terminal.

As a more specific example, it is assumed that the utilization position information included in the second terminal information 102 indicates “destination of going out”.

Step S4:

As a result of referring to the portlet information 11 based on the utilization position information which is included in the received second terminal information 102, and the acquired classification information of the terminal, the content generating unit 2 acquires a bandwidth and a portlet name which are associated with the utilization position information and the classification of the terminal.

As a more specific example, the content generating unit 2 acquires “200 kbps” corresponding to the bandwidth, and “portlet A” corresponding to the portlet name which are shown in FIG. 4 and which are associated with information indicating “destination of going out” corresponding to the utilization position information included in the received second terminal information 102, and information indicating “mobile terminal” corresponding to the acquired classification of the terminal.

Step S5:

The content generating unit 2 calculates the second priority P2 based on the screen size and the memory size which are included in the received second terminal information 102, and the acquired bandwidth.

Here, as an example, it is assumed that the second priority P2 calculated by the content generating unit 2 is “3”.

Step S6:

The content generating unit 2 refers to the priority information 4, which the storage unit 3 holds, based on the calculated second priority P2 and the acquired portlet name.

As a more specific example, the content generating unit 2 refers to the priority information 4, which the storage unit 3 holds, based on the portlet information (portlet A) acquired in Step S4, and the second priority P2 (“3”) calculated in Step S5.

Step S7:

As a result of referring to the priority information 4 based on the second priority P2 and the portlet name, the content generating unit 2 acquires information indicating a display range which is associated with the portlet name and a priority range including a value of the second priority P2.

As a more specific example, as a result of referring to the priority information 4 based on the portlet information (portlet A) acquired in Step S4, and the second priority P2 (“3”) calculated in Step S5, the content generating unit 2 acquires the information indicating the display range which is associated with the portlet name and the priority range including the value of the second priority P2.

As an example, the acquired display range is corresponding to “L1-L5” (that is, from a first line to a fifth line) in the example shown in FIG. 2.

Step S8:

The content generating unit 2 supplies the terminal 22 with the portlet name acquired in Step S4, and the information which indicates the display range associated with the portlet and which is acquired in Step S7, and then ends the process.

The web browser of the terminal 22 receives the portlet content information, and displays the received portlet content information to the user via an user interface such as a display device or the like (not shown in the figure) of the terminal 22.

As a more specific example, according to the example shown in FIG. 2, the web browser of the terminal 22 displays the first line to the fifth line of the portlet A as the portal site based on the received content information.

For example, in the case that an user desires to browse a sixth line and lines following the sixth line of the portlet A, the user sends the request to the portal server 21 by operating the web browser.

As a result, the portal server 21 supplies the portlet content information, which is corresponding to the sixth line and the lines following the sixth line of the portlet A, in response to the request.

The web browser of the terminal 22 receives the portlet content information including the sixth line and the lines following the sixth line, and displays the sixth line and the lines following the sixth line of the portlet A on the display device based on the received portlet content information. However, the present invention, which is exemplified by the exemplary embodiment, is not limited to the configuration mentioned above (above mention is similar in the following exemplary embodiment).

As mentioned above, the portal system 20 according to the exemplary embodiment can obtain the same effect as one which is explained in the first and the second exemplary embodiments mentioned above.

(Example of Hardware Configuration)

Each unit which is shown in the figure according to the above-mentioned exemplary embodiment can be regarded as a function (process) unit (software module) of a software program. Each software module may be realized by a dedicated hardware. Here, division into each unit shown in the figures is carried out in order to make the description on the configuration easy. When installing, various configurations can be assumed. An example of a hardware environment in this case will be described with reference to FIG. 7.

FIG. 7 exemplifies a configuration of an information processing apparatus 300 (computer) which can carry out the content supplying apparatus according to the above-mentioned exemplary embodiment of the present invention. That is, FIG. 7 shows a configuration of a computer (information processing apparatus) of a server or the like which can realize all or some of the content supplying apparatuses of the portal system 20 including the content supplying apparatus 1 shown in FIG. 1, the content supplying apparatus 1 shown in FIG. 3 or the content supplying apparatus 1 shown in FIG. 5, and shows a hardware environment which can realize each function in the exemplary embodiment mentioned above.

The information processing apparatus 300 shown in FIG. 7 includes CPU (Central_Processing_Unit) 301, ROM (Read_Only_Memory) 302, RAM (Random_Access_Memory) 303, a hard disk 304 (storage device), a communication interface (Interface: hereinafter, referred to as “I/F”) 305 with an external apparatus, a reader/writer 308 which can read and write data from and in a storage medium 307 respectively such as CD-ROM (Compact_Disc_Read_Only_Memory) or the like, and a general output unit 309 as the user interface. Moreover, these components are connected each other via a bus 306 (communication wire). Therefore, the information processing apparatus 300 is the general computer.

Then, the present invention, which is exemplified by the above-mentioned exemplary embodiment, is realized by supplying the information processing apparatus 300 shown in FIG. 7 with a computer program which can realize the function of the block diagram (FIG. 1, FIG. 3 and FIG. 5) or the flowchart (FIG. 6) referred to in the description, and afterward by making CPU 301, which is hardware, read and execute the computer program. Moreover, it is enough that the computer program, which is supplied within the apparatus, is stored in a temporary memory (RAM 303) from and in which data can be read and written respectively, or in a non-volatile storage device such as the hard disk 304 or the like.

In this case, the method, which is general at this point of time, such as the method of installing the computer program within the apparatus via various storage media 307 like CD-ROM or the like, or the method of downloading the computer program from an outside via a communication circuit such as the Internet or the like can be used as a method for supplying the computer program within the hardware. Moreover, in this case, it is conceivable that the present invention is realized by codes which are included in the computer program or by a storage medium which stores the code.

1. A content supplying apparatus comprising:
calculating, a first priority based on first terminal information, indicating information on a configuration of a terminal which accesses a portal site;
by referring to priority information obtained by associating a portlet included in the portal site, a priority range indicating a range to which the first priority can be applied and a display range in the portlet, based on any portlet and the calculated first priority, acquiring information indicating the display range associated with the any portlet and the calculated first priority; and
supplying the any portlet and the acquired information indicating the display range to the terminal.

2. The content supplying apparatus according to claim 1, wherein:
by referring furthermore to portlet information, which is obtained by associating terminal classifying information indicating a classification of the terminal, utilization position information indicating a position where the terminal accesses the portal site, a bandwidth of a network circuit used by the terminal, and the portlet, based on second terminal information indicating information on a configuration of the terminal, and specific terminal classifying information out of the terminal classifying information, acquiring a specific portlet and a specific bandwidth associated with the second terminal information and the specific terminal classifying information;
calculating a second priority based on the second terminal information and the acquired specific bandwidth;
by referring to the priority information based on the acquired specific portlet and the calculated second priority, acquiring information indicating the display range in the portlet which is associated with the acquired specific portlet and the calculated second priority; and
supplying the terminal with the acquired specific portlet and the acquired information indicating the display range.

3. The content supplying apparatus according to claim 1, wherein:
the first terminal information includes a screen size of a display device of the terminal and a memory size of the terminal which is available when browsing the portal site.

4. The content supplying apparatus according to claim 2, wherein:
the second terminal information includes information on the utilization position in addition to information which the first terminal information includes.

5. The content supplying apparatus according to claim 4, wherein:
the utilization position information is an IP address which is assigned to the terminal.

6. The content supplying apparatus according to claim 1, wherein:
the first priority is calculated based on the screen size and the memory size, which are included in the first terminal information.

7. The content supplying apparatus according to claim 2, wherein:
the second priority is calculated based on the screen size and the memory size which are included in the second terminal information, and the acquired bandwidth.

8. A portal system including a terminal and a portal server which is able to supply a portal site in response to a request received from the terminal via a communication circuit, wherein:
the terminal includes a terminal information acquiring unit which acquires information on a configuration of an own apparatus and generates first terminal information;
the portal server calculates, in response to receiving the first terminal information, a first priority based on the first terminal information;
by referring to priority information, which is obtained by associating a portlet included in the portal site, a priority range indicating a range to which the first priority can be applied, and a display range in the portlet, based on any portlet and the calculated first priority, the portal server acquires information indicating the display range associated with the any portlet and the calculated first priority; and
the portal server supplies the terminal with the any portlet and the acquired information indicating the display range.

9. The portal system according to claim 8, wherein:
in response to receiving second terminal information indicating information on a configuration of the terminal, by referring furthermore to portlet information, which is obtained by associating terminal classifying information indicating a classification of the terminal, utilization position information indicating a position where the terminal accesses the portal site, a bandwidth of a network circuit used by the terminal and the portlet, based on the second terminal information indicating information on the configuration of the terminal, and specific terminal classifying information out of the terminal classifying information, the portal server acquires a specific portlet and a specific bandwidth associated with the second terminal information and the specific terminal classifying information;
the portal server calculates a second priority based on the second terminal information and the acquired specific bandwidth by carrying out a predetermined calculation;
by referring to the priority information based on the acquired specific portlet and the calculated second priority, the portal server acquires information indicating the display range in the portlet which is associated with the acquired specific portlet and the calculated second priority; and
the portal server supplies the terminal with the acquired specific portlet and the acquired information indicating the display range.

10. A content supplying method, comprising:
calculating a first priority based on a first terminal information indicating information on a configuration of a terminal which accesses a portal site;
by referring to priority information obtained by associating a portlet which is included in the portal site, a priority range indicating a range to which the first priority can be applied and a display range in the portlet, based on any portlet and the calculated first priority, acquiring information indicating the display range associated with the any portlet and the calculated first priority; and
supplying the terminal with the any portlet, and the acquired information indicating the display range.

11. The content supplying method according to claim 10, comprising:
by referring furthermore to portlet information obtained by associating terminal classifying information indicating a classification of the terminal, utilization position information indicating a position where the terminal accesses the portal site, a bandwidth of a network circuit used by the terminal and the portlet, based on second terminal information indicating information on a configuration of the terminal and specific terminal classifying information out of the terminal classifying information, acquiring a specific portlet and a specific bandwidth associated with the second terminal information and the specific terminal classifying information;
calculating a second priority based on the second terminal information and the acquired specific bandwidth;
by referring to the priority information based on the acquired specific portlet and the calculated second priority, acquiring information indicating the display range in the portlet which is associated with the acquired specific portlet and the calculated second priority; and
supplying the terminal with the acquired specific portlet and the acquired information indicating the display range.

12. A non-transitory computer readable media storing a computer program controlling an operation of a content generating apparatus, causing a computer to realize:
calculating a first priority based on first terminal information, indicating information on a configuration of a terminal which accesses a portal site;
by referring to priority information obtained by associating a portlet included in the portal site, a priority range indicating a range to which the first priority can be applied and a display range in the portlet, based on any portlet and the calculated first priority, acquiring information indicating the display range associated with the any portlet and the calculated first priority; and
supplying the terminal with the any portlet, and the acquired information indicating the display range.
